(19) United States
(12) Patent Application Publication
(10) Pub. No.: US 2017/0301187 A1
(43) Pub. Date: Oct. 19, 2017

(54) MULTI-PLAYER GAMES BASED ON IDENTIFICATION CARDS

(71) Applicant: Rikki Tahta, New York, NY (US)

(72) Inventor: Rikki Tahta, New York, NY (US)

(21) Appl. No.: 15/472,992

(22) Filed: Mar. 29, 2017

Related U.S. Application Data
(60) Provisional application No. 62/322,574, filed on Apr. 14, 2016.

(51) Int. Cl. G07F 17/32

(52) U.S. Cl. CPC G07F 17/3276; G07F 17/3293; G07F 17/3211; G07F 17/3239; G07F 17/3251

(57) ABSTRACT

A system and a process are provided for a game based on six or more players using scannable identification (ID) cards to compete in a game with all the users physically co-located. The games utilize scannable identification cards uniquely assigned to individual users in a game. The scannable ID cards include indicia such as barcodes and quick response (QR) codes, magnetically coded strips, embedded integrated circuits (IC), and radio frequency identification (RFID) chips, or combinations thereof. During game play the users register at different gaming stations to record or log their progress or to take a game related action. Gaming stations include a card scanner or card reading device, a computer processor, wired or wireless network connections, an input device (e.g., keyboard, mouse), and a display screen that may also have touch screen capabilities for data entry.

### CROSS-REFERENCE TO RELATED APPLICATION

This application claims priority of U.S. Provisional Patent Application Ser. No. 62/322,574 filed Apr. 14, 2016, which is incorporated herein by reference.

### FIELD OF THE INVENTION

The present invention in general relates to the field of gaming and in particular to a game played with readable identification cards.

### BACKGROUND OF THE INVENTION

Games play an important social function in creating comity between individuals as well as an affirming communal experience. While traditional games can provide this experience in small groups of perhaps up to eight individuals, in larger group settings to complexity of organizing and operating traditional games such as card play or board games often overshadows these positive attributes with the result that the larger group fragments into clannish subgroups.

Identification (ID) cards with scannable features have become commonplace in society. Scannable features of ID cards may include indicia such as barcodes and quick response (QR) codes, magnetically coded strips, embedded integrated circuits (IC), and radio frequency identification (RFID) chips. Furthermore, the costs associated with including the scannable features in ID cards are almost negligible.

Thus, with the widespread use and low cost of scannable features, the use of scannable features may be extended beyond identification cards to gaming can overcome the limitations of traditional analog games and create the comity and communal experiences to analog games in a larger group setting and without the distractions of leader instructions.

### SUMMARY OF THE INVENTION

A system includes multiple identification (ID) cards with digitally scannable attributes individually assigned to a a group of at least six users, stations are provided and configured to read the ID cards. A server is in communication with the stations. The server is configured to store information related to the ID cards, and to record actions taken with the various ID cards at the stations.

A game played with the system as described wherein six or more users register at different stations to record or log their progress or to take a game related actions.

A non-transitory computer-readable medium for implementing an automated system of stations and a server that when executed on a processor, assign at least one identification (ID) cards to each individual user. The user interaction is registered between the ID cards and the stations. The user interaction with the stations is transmitted to a server from the stations for recordation of the user interaction to provide scoring and progress of the individuals through the game.

### BRIEF DESCRIPTION OF THE DRAWINGS

The present invention is further detailed with respect to the following non-limiting specific embodiments of the present invention. The appended claims should not be construed as being limited to the specific devices so detailed.

FIG. 1 is block diagram of a scannable identification card according to an embodiment of the invention; and

FIG. 2 is block diagram of a system set up using scannable identification cards of FIG. 1 assigned to individual users according to an embodiment of the invention.

### DETAILED DESCRIPTION OF THE INVENTION

The present invention has utility as a game based on players using scannable identification (ID) cards to compete in gaming competitions. Embodiments of the inventive game utilize scannable identification cards uniquely assigned to individual users in a game. The scannable ID cards may illustratively include indicia such as barcodes and quick response (QR) codes, magnetically coded strips, embedded integrated circuits (IC), and radio frequency identification (RFID) chips, or combinations thereof. During game play six or more users register at different gaming stations to record or log their progress or to take a game related action. It is appreciated that the six or more users includes tens, or even hundreds of users co-located. Gaming stations may include a card scanner or card reading device, a computer processor, wired or wireless network connections, an input device (e.g., keyboard, mouse), and a display screen that may also have touch screen capabilities for data entry. In contrast on various on-line gaming, the users of the inventive game are physically located in the same physical space.

During game play, a gaming user takes their assigned ID card to a gaming station to complete an action, or to record their progress in a game. For example, a user may have to actively swipe their ID card to read their magnetic strip, insert their card to read the IC mounted to the card, or passively pass the IC or RFID in the vicinity of the station to have their ID card read or recorded via near field communication or via a passive or active RFID return signal. It is appreciated that depending on the number of users, a given type of station is provided in duplicate to allow for simultaneous like actions by two or more of the users. Central to the inventive game are the digital recordation by a card reader station of the ID of the card being logged and therefore, the user associated therewith, the timing of the recordation and the station on which the recordation occurred; with this information alone a large group game is played.

In a specific embodiment, six or more users attending a conference or within a company or organization are assigned a unique ID card. During game play participants move between game stations to have their ID card read and recorded. In a specific embodiment in the context of a stock trading game, a first station (station 1) is used to “buy a stock” and second station (station 2) is used to “sell a stock”. During the game the stock price is constantly changing on some information screen. When a participant wants to buy a stock, they go to station 1 and present or swipe their card. A central server registers their purchase, the price, and records the time of purchase. When the user wants to sell their stock, they go to station 2 and present or swipe their ID card and likewise the server calculates the individual user gain/loss and adjusts their gaming totals and portfolio profile.

In still other gaming situations, embodiments of the inventive ID card may be assigned to participants in focus groups or market research studies, where a participant may present their ID card to record their selection from amongst a set of products. Furthermore, in an actual trading situation, such as in a trading pit on an exchange, traders may use their assigned ID cards to enter trades on terminals on the trading floor.

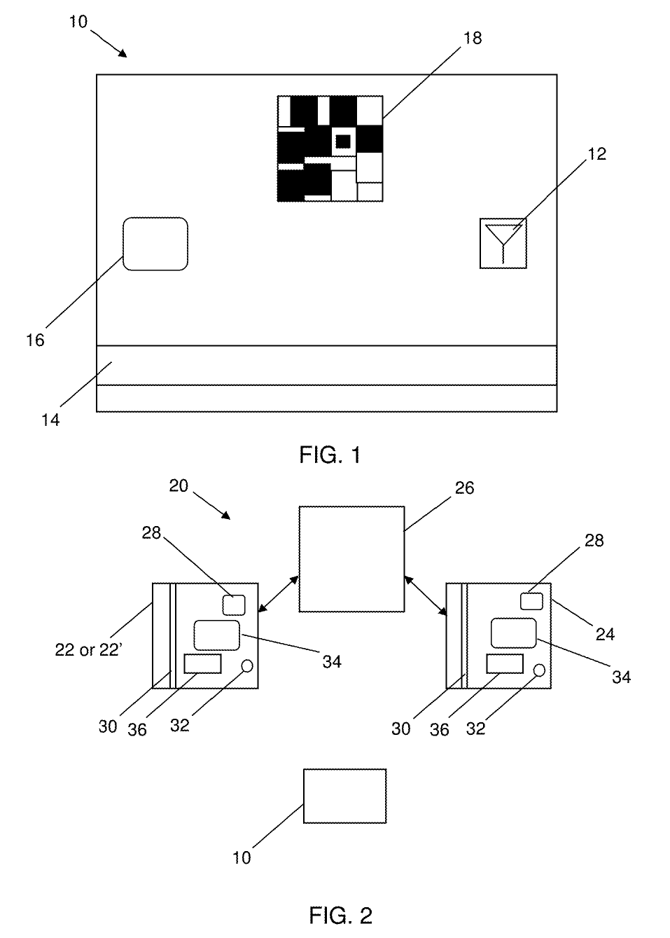

With reference to the attached figures, an embodiment of an inventive ID card is depicted generally at 10 in FIG. 1. The ID card 10 may be configured with one or more of a passive or active RFID chip 12, a magnetic strip 14, an integrated circuit chip 16, and a scannable indicia 18 illustratively including barcodes and quick response (QR) codes.

FIG. 2 is a view of a system 20 with a first station 22 and a second station 24. It is appreciated that more than two stations may be part of the system 20. Station 22 is depicted along with a duplicate to station 22, 22′ to afford two places were a user can perform the action recorded at station 22. Similarly, station 24 is also readily duplicated (not shown). With duplicate or even multiple version of each kind of station a large number of users including tens or even hundreds of users can play the game simultaneously. The stations (22, 22′, 24) may be in wireless communication or wired communication (bidirectional arrows) via a network to a central server 26. The server 26 may be used to store information related to the ID cards 10 individually assigned to two or more users, and to record actions taken with the ID cards 10 at the stations (22, 22′, 24). The stations (22, 22′, 24) may be configured with one or more of a wireless chip/RFID reader 28, a magnetic strip reader/slot 30, and a barcode reader/camera 32, a display 34, and an input device 36.

The central server 26 in some inventive embodiments is coupled to an audiovisual display to provide questions or other input to the users to which they respond with card reading at a station. In still other embodiments, the central server includes a display of results so users can assess their relative progress toward an objective or scoring in the game. In some inventive embodiments, input or questions are targeted to specific users to create a bonus or handicapping feature thereby keeping users engaged regardless of their relative ranking. An example of an input operative herein is a clue or option not otherwise available to all game users.

The foregoing description is illustrative of particular embodiments of the invention, but is not meant to be a limitation upon the practice thereof. The following claims, including all equivalents thereof, are intended to define the scope of the invention.

1. A game system comprising:
a plurality of identification (ID) cards individually assigned to a plurality of at least six users, each of said plurality of ID cards being digitally readable;
a plurality of stations configured to digitally read said plurality of ID cards and located physically in a common location; and
a server in communication with said plurality of stations, said server is configured to store information related to said plurality of ID cards, and to record actions taken with said plurality of ID cards at said plurality of stations to determine relative scoring or progress toward a game objective.

2. The system of claim 1 wherein said plurality of ID cards further comprise a radio frequency identification (RFID) chip.

3. The system of claim 1 wherein said plurality of ID cards further comprise on or more of an RFID chip, an integrated circuit, a coded magnetic strip, or a scannable indicia.

4. The system of claim 3 wherein said scannable indicia is a barcode or a quick response (QR) code.

5. The system of claim 1 wherein said plurality of stations comprise one or more of a wireless chip/RFID reader, a magnetic strip reader/slot, and a barcode-indicia reader/camera.

6. The system of claim 5 wherein at least one of said plurality of stations further comprises a video display, or a data input interface.

7. A process of playing a game with the system of claim 1 wherein each of six or more users digitally registers individually at a station of said plurality of stations in a gaming area to record progress or to take a first game related action; and
each of the six or more users repeats the digitally registering individually at said station or a different station of said plurality of stations in the gaming area to record an additional increment of progress or to take a second game related action.

8. The process of claim 7 wherein said station logs “buy a stock” and said different station of said plurality of stations logs “sell a stock” and during a finite game term, a game stock price is dynamically changing on an information screen.

9. The process of claim 7 wherein the six or more users actively swipe ID cards to read a magnetic strip on each of said ID cards, insert each of said ID cards to read an, or passively pass each of said ID cards by an IC reader or an radio frequency ID (RFID) reader in the vicinity of said station.

10. The process of claim 7 wherein said station has a visual display associated therewith.

11. The process of claim 7 further comprising providing an audiovisual display to provide a question or other input to the six or more users.

12. The process of claim 12 further comprising targeting a specific user from among the six or more users with said question or other input.

13. The process of claim 7 further comprising providing display of results for each of the six or more users.
